(19) United States
(12) Patent Application Publication
(10) Pub. No.: US 2024/0083552 A1
(43) Pub. Date: Mar. 14, 2024

(54) MOORING SYSTEM

(71) Applicant: TJOLOLO AB, Västerås (SE)

(72) Inventor: Bertil MORITZ, Västerås (SE)

(21) Appl. No.: 18/263,252

(22) PCT Filed: Jan. 27, 2022
(86) PCT No.: PCT/SE2022/050083

§ 371 Date: Jul. 27, 2023

(30) Foreign Application Priority Data
Jan. 28, 2021 (SE) 2100015-3

(51) Int. Cl. B63B 21/50; B63B 35/44; B63B 77/10; F03D 13/25

(52) U.S. Cl. CPC B63B 21/508; B63B 35/44; B63B 77/10; F03D 13/256; B63B 2035/446; F05B 2240/93

(57) ABSTRACT

A mooring system for mooring a floating platform having a plurality of stabilizing arms with floats, the mooring system including an anchoring system containing a plurality of anchors and anchoring cables for anchoring the mooring system in deep sea. The center part of the mooring system includes a mooring unit containing a plurality of mooring elements and positioning wires, where each mooring element is connected to an adjacent mooring element with a positioning wire and to an anchor.

### TECHNICAL FIELD

The present invention concerns a mooring system for a floating object in deep sea. Especially the invention concerns a stationary mooring system comprising an anchoring system with a plurality of anchors. More precisely the mooring system comprises means for mooring a floating platform at sea.

### BACKGROUND OF THE INVENTION

A great many anchoring systems are known for anchoring a floating platform at sea. Most anchoring systems comprises a plurality of anchors for anchoring a floating platform in a desired position and orientation. The anchors are often organized in patterns to keep a plurality of floating platforms in a desired geographic position at all wind and weather conditions. The anchors may be traditionally digging anchors, gravity anchors but preferably suction anchors. The anchor lines may comprise catenary lines or taut leg lines.

A floating object to be held in a desired position may comprise a floating semi-submerged wind power plant. Such plant comprises a structural platform containing a plurality of buoyancy element. The platform carries a single or a plurality of rotor towers. The buoyancy elements comprise an inner cavity into which water is filled to submerse the platform. In its operational state the platform is submersed to a level where only the buoyancy elements penetrate the water surface. Thus in its operational state only the tower and the top of the buoyancy elements can be seen above the sea surface. A great number of different types of semi-submersible platforms for generating wind power have been suggested. Most of them have one single turbine on top of a tower.

A floating platform may comprise a wind turbine tower and the aim is to direct the rotor shaft of the turbine into the wind. A first type of platforms uses the principle of a weather vane. This rotatable platform is anchored at a single point and the platform is turned by the wind to a direction with the wind in which the rotor shaft faces the wind. Thus the tower needs no pivotable wind turbine. A second type of platforms comprises a stably oriented floating construction comprising a tower with a pivotal rotor. This type of platform often comprises a plurality of arms with floating element to stabilize the tower. Such a platform needs to be stably anchored in a desired position and orientation to make possible the pivotable rotor being able to be directed towards the wind.

The long-term accuracy of positioning the wind power units is important. If drag anchors are used, the accuracy is not sufficient. The anchoring lines are pulled until the anchor catch sufficient grip to the sea bed. Hence the seabed conditions may cause the anchor and thereby the platform to change its position hundreds of meters from a desired position. Therefore, position reliability requires the use of suction anchors.

From US2019024635 (Siegfriedsen) an offshore wind farm with a plurality of foundation elements is previously known. The foundation elements are arranged so as to form the corners of a plurality of parquetted hexagons and with a plurality of floating offshore wind turbines. Each floating offshore wind turbine within a hexagon is connected to the foundation elements which form the hexagon. The floating offshore wind turbines are connected to the foundation elements via sagging connectors designed as a chain or a cable or a combination of a chain and a cable. The connection means have a length which allows the offshore wind turbines to drift within a circular area with a radius of up to 10% of the hexagon circumradii about the respective hexagon centre.

The floating offshore wind turbines are constructed as weather vanes. Thus the wind turbine platform is anchored at one point only. Then the platform assumes a direction with the wind. According to the known offshore wind farm the platform is anchored with one buoy element only. Thus each buoy element is anchored with six anchor lines in a hexagon pattern.

From JP 2004176626 (Takada) an offshore wind power generation facility is previously known. The object is to provide an offshore wind power generation facility which can be placed on the ocean easily even in a deep-sea areas, which keeps respective floating bodies moderately apart from one another even under severe weather and ocean conditions. The facility prevents the power generating capacity from being reduced when the relative positional relationship between wind power generation equipment is changed. The facility comprises a plurality of floating bodies which respectively support the wind power generation equipment or supports control equipment. The floating bodies are connected to one another by means of anchoring chains each having an intermediate sinker in the middle of the chain. The floating bodies positioned at the outermost location are further connected to anchors at their one ends by means of chains each having an intermediate sinker in the middle of the chain. The floating bodies and the anchors are arranged to connect a plurality of element structures of plan view equilateral triangles.

An advantage of a floating platform is that it may be fully fabricated at a shipyard and thus reduce the installation cost. It is then transported to a desired location and permanently anchored to an anchor system. It is, however, desirable to be able to tug the platform back to the shipyard for major repair and maintenance. It is therefore preferable to avoid installing an anchoring system each time. Already when planning and deploying a wind farm with a plurality of floating platforms, it is desirable to first establish an infrastructure of electric cabling and an anchoring system.

### SUMMARY OF THE INVENTION

A primary object of the present invention is to seek ways to improve the mooring of a floating object to an anchoring system in deep sea.

These objects are achieved according to the invention by a mooring system characterized by the features in the independent claim 1, by a mooring facility characterized by the features in the independent claim 8, by a method of providing a mooring system characterized by the features in the independent claim 9, or by a method of docking a floating platform to a mooring system characterized by the features in the independent claim 10. Preferred embodiments are described in the dependent claims.

A mooring system according to the invention comprises an anchoring system and a mooring unit. By a mooring unit in this context is understood means for mooring a floating object. In an embodiment of the invention the mooring unit comprises a plurality of anchored mooring element held together by positioning wires to form a triangular pattern to which a floating platform may be moored. The anchor system comprises a plurality of widely spread anchors and anchor lines in a triangular pattern. Thus while the mooring unit is permanently anchored by the anchoring system a moored object may be attached to and detached from the mooring unit. According to the invention the mooring system allows a platform to be stationary moored at a specific location and orientation but still be capable of being set free for maintenance transportation. Whereas known anchoring systems comprises only anchors and anchoring cables a mooring system according to the invention comprises in addition to the anchoring system a mooring unit. The anchoring system comprises a plurality of anchors connected by prestressed cables to the mooring unit.

In an embodiment the mooring unit comprises a plurality of mooring elements positioned in the centre of the anchoring system. Each mooring element comprises a floating container having a cavity in which the amount of air and water may be regulated. By filling water into the cavity the height position in the sea may be lowered. In the embodiment each of the mooring elements is held in positions by three cables. In an embodiment two of these cables comprises a positioning wire connected to an adjacent mooring element. The third cable comprises an anchoring cable connected to an anchor at the sea bed. By the positioning wire the mooring elements are held at a predetermined position separated from each other.

In an embodiment of the invention the mooring element comprises an elongated container having a small cross section area. By a small cross section in this context should mean about one tenth of the length of the element. In an embodiment the elongated container is vertically aligned by added ballast weight in the bottom. In an embodiment the top part of the mooring element comprises a funnel shaped container and the bottom part comprises a cylindric container. The containers act as communicating cavities in which water or air may be filled. By balancing the content of air and water in the container the buoyancy and the height position of the mooring element may be controlled. Thus the mooring element may be recognized as a submersible buoy in the sea.

The small cross section area of the cylindric mid part of the element has the effect to calm the movement of the mooring element and thus the movement of the platform in harsh sea. The movement of the element by the buoyancy force may be seen as the oscillation of a spring. The cross-section area and thereby the imprint in the water comprises the spring constant. Narrowing the imprint will decrease the spring constant and thus lower the heave and roll natural frequency of the platform in the sea. The funnel shaped top part provides an increasing buoyancy effect along its length which further calms the movement of the element in big waves. In an embodiment the cylindric bottom part of the element has a bigger cross section area and is mainly used for controlling the buoyancy and height level of the mooring element in sea.

In an embodiment the mooring unit comprises submersible mooring elements organized in the centre of the anchoring system. Each mooring element is connected to another mooring element with a positioning wire and to an anchor with an anchoring cable. In an embodiment the mooring elements are organized in a triangle with a mooring element in each corner. Each mooring element is connected to two adjacent mooring element and to the anchoring system. Thus the anchoring system is also organized in a triangular pattern. Each mooring element is partly connected to an anchor and partly to each adjacent mooring element by the positioning wire. Thus each mooring element is anchored with three cables, an anchoring cable and two positioning wires. By this arrangement the three mooring elements form corners in a stable triangle held in position by three anchors.

In an embodiment each mooring element comprises a dockable buoy. In this embodiment the mooring element comprises dockable means to be docked with a dockable float of a floating platform. In an embodiment the dockable means comprises a plurality of transversal bars to which the docking means of a float may hook to form an entirety. Thus by having the mooring element and the float to mate tightly together a single common floating member is formed by which all anchor forces may be transferred to the moored object. At the same time the mooring element contributes to the stability of the platform.

The floating platform is normally stabilized by its floats. The buoyancy of the floats must therefore be dimensioned by the stabilizing forces needed in the worst weather conditions. But by docking the mooring element to the float a new entity is formed which together stabilizes the platform. Thus the buoyancy of the float needs only to be dimensioned for transport conditions only. And the mooring element needs only to be dimensioned to stay positioned in the sea.

The anchors of the anchoring system are organized such that the moored object is kept in a desired geographic position and orientation at all wind and weather conditions. The anchors may be traditionally digging anchors, gravity anchors but preferably suction anchors. The anchor lines may comprise catenary lines but preferably taut leg lines or a mixture of both. In an embodiment the anchor lines comprise prestressed cables of an armed non-metallic fibre.

A floating object to be moored to the mooring system may comprise a floating semi-submerged wind power plant. Such a plant comprises a structural platform containing a plurality of arms each containing a buoyancy element. The platform may comprise a tower with a pivotal nacelle and a wind turbine. The buoyancy elements comprise a floating container having an inner cavity into which water is filled to submerse the platform. In its operational state the platform is submersed to a level where only the buoyancy elements penetrate through the water surface. A preferred design of a floating platform comprises three arms having an outer buoyancy element in the form of a float. A connecting cable may be attached to each float to keep the floats and arms equally spread around the tower.

Both the dockable floats of the platform and the mooring elements of the mooring system may comprise elongated floating containers with a small cross section area. The height position in the sea is adjusted by filling or emptying water in the floats and the mooring elements respectively. The amount of water in the cavity is controlled by pumping air into the container or pumping water out of the container. In an embodiment air is pumped into the cavity to control the buoyancy effect and the height position in the sea. An opening or a valve in the bottom part of the mooring element allow the water to enter the cavity.

The docking process is achieved by a relative height movement of the float and the mooring element. In an embodiment the method of docking comprises that the height of the mooring elements is lowered in the sea and the height of the floats is raised. Thereafter the floating object is moved in between the mooring elements such that the mooring element and the floats are face to face and in position to dock. Then the height of the float is lowered and the height of the mooring element is raised respectively. After mating in this way the float and the mooring element form a common single floating unit capable of resisting all movement in the sea and transferring all forces between the anchors and the floating platform. In an embodiment any of the docking elements may comprise a locking means.

Building up a large park of mooring systems at sea may start with one mooring system using three anchors. A second mooring system is anchored adjacent the first mooring system. Further mooring systems are anchored adjacent each other in a hexagon pattern comprising six mooring systems. Since a plurality of anchors may be used by two or more mooring systems six mooring systems in a hexagonal pattern need only seven anchors. Further extension of the mooring park to comprise a vast number of mooring systems decrease the number of anchors needed for each platform. The limit for a huge number of platforms tends to two mooring systems for every anchor. Since all anchoring cables are prestressed and connected between a mooring element and an anchor electric service cabling may be attached and held by the anchor cable. In an embodiment of the invention an infrastructure of electric cabling and services is installed in the mooring element to be directly plugged in. The docking means may comprise the contact devise for the electric service.

In an embodiment of the invention a second arrangement of a plurality of mooring systems are organised. This second set of mooring systems are somewhat rotated to the original set of mooring systems in order to use the already existing set of anchoring systems. Thus for each hexagonally arranged mooring system a new mooring system may be anchored at the existing anchoring system. For a fully extended mooring plant with both the first and second arrangements of mooring systems the limit tends to three mooring systems for every anchor.

In a first aspect the object is achieved by a mooring system for mooring a floating platform having a plurality of stabilizing arms with floats, wherein the mooring system comprises an anchoring system containing a plurality of anchors and anchoring cables for anchoring the mooring system in deep sea, and wherein the centre part of the mooring system comprises a mooring unit containing a plurality of mooring elements and positioning wires, and where each mooring element is connected to an adjacent mooring element with a positioning wire and to an anchor. In a further aspect each mooring element comprises an elongated floating container having a common cavity for ballast water. Each mooring element comprises a funnel shaped upper part, a cylindric mid part with a small cross section area and a cylindric bottom part.

In a second aspect the object is achieved by a method for providing a mooring system for a floating wind power platform comprising a plurality of buoys anchored by anchoring cables in deep sea, wherein the method comprises providing a mooring unit containing three mooring elements, anchoring each mooring unit with an anchor, positioning the three mooring elements in a triangular pattern by keeping them separated by a positioning wire.

In a third aspect the object is achieved by a method of docking a floating platform having a plurality of floats with a mooring system containing docking means, comprising transporting the platform in a float position to the mooring site, submersing each of the mooring element of the mooring system to a receiving position by filling ballast water into a buoyancy compartment of the mooring element, positioning the floats of the floating platform face to face with the mooring elements, raising the mooring elements and lowering the floats to make the docking means to interlock by regulating the amount of ballast water in the float and in the mooring element respectively.

### BRIEF DESCRIPTION OF THE DRAWINGS

Other features and advantages of the present invention will become more apparent to a person skilled in the art from the following detailed description in conjunction with the appended drawings in which:

FIG. 1. is plan view of a mooring system according to the invention and a floating platform to be moored,

FIG. 2. is a plan view of mooring facility comprising a plurality of mooring systems,

FIG. 3. Is a plan view of a method to moor a floating platform,

FIG. 4. is a section view of a part of a floating platform ready to dock with a mooring element, and

FIG. 5. Is a three-dimensional sketch of the docking of a float and a mooring element.

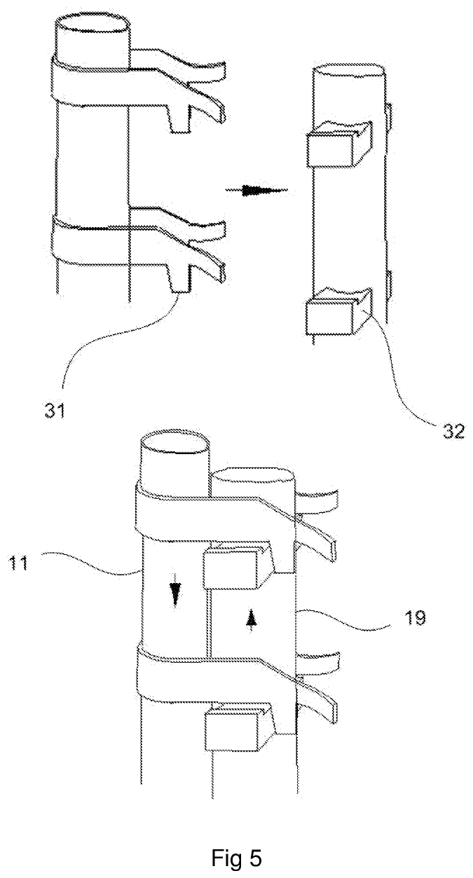

### DESCRIPTION OF PREFERRED EMBODIMENTS

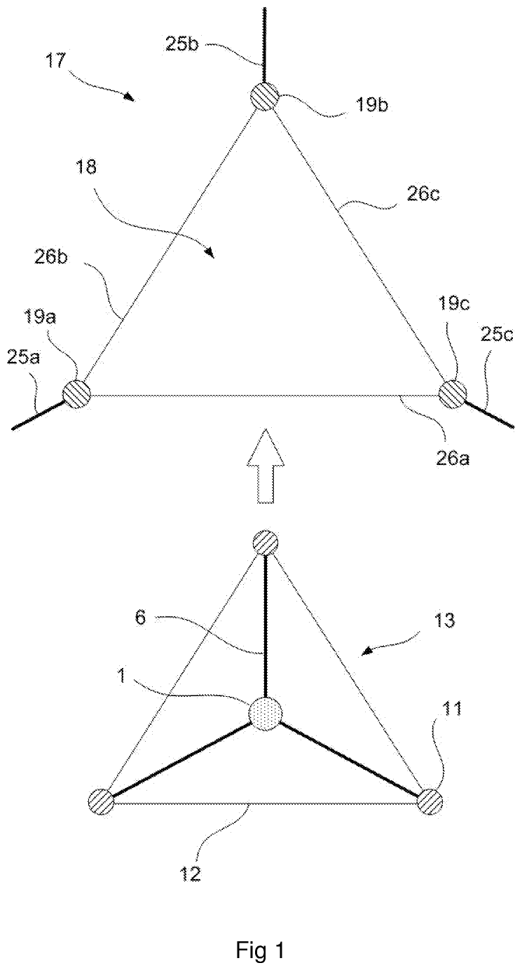

A mooring system 17 comprising an anchoring system 16 and a mooring unit 18 is shown in FIG. 1. The mooring unit is permanently anchored by the anchoring system. The mooring unit 18 comprises in the embodiment shown three mooring elements 19 as corners in a triangular pattern. The mooring elements are connected with each other with a positioning wire 26 to be kept at a desired separation from each other. Each mooring element is thus secured by two adjacent mooring elements with a positioning wire and by an anchor 27 (not shown) with an anchoring cable 25. Thus the mooring unit forms a mooring triangle with a mooring element in each corner. The mooring element 19 comprises a floating vertically elongated container suitable to be filled with a mixture of water and air. By controlling the content of that mixture the buoyancy effect and the height position of the mooring element may be controlled.

A floating platform 13 to be received by the mooring unit 18 is also shown in FIG. 1. In the embodiment shown the floating platform comprises a tower 1 stabilized by three arms 6. The outer end of each arm includes a float 11 comprising a floating elongated container. The elongated container is vertically aligned. All of the floats are connected with each other with a connecting wire 12 to make the arms equally spread around the tower. The float may be filled with a mixture of water and air to receive a desired buoyancy effect ant to define its height level in the sea.

When mooring the floating platform it is first transported into the mooring unit 18 by for instance a tug boat. Upon arrival of the platform the mooring element 19 are lowered in the sea by filling water into their inside compartments. Thereby the platform in its transport height will be capable of passing into the mooring unit triangle over the positioning wires. When the floating platform is positioned inside the mooring triangle each float 11 of the floating platform is facing a mooring element 19. Thus each float may be moored to the facing mooring element. In an embodiment the mooring is achieved by a rope, cable or the like. In an embodiment the float and the mooring element is equipped with docking means by which the two entities dock to form a single unit.

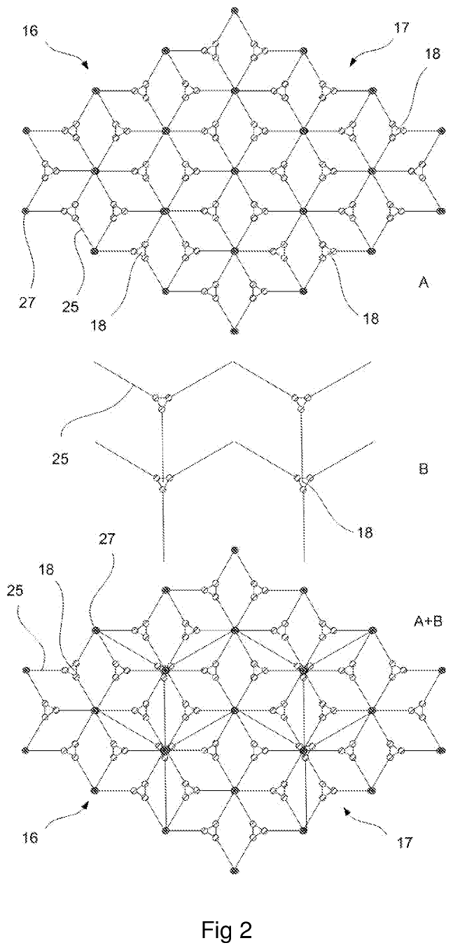

A facility of a great number of mooring systems 17 anchored by anchoring cables 25 to anchors 27 is shown in FIG. 2. As can be seen by the embodiment shown a single mooring system must use three anchors. But the more mooring systems included in the mooring facility the fewer anchors are needed. For a vast number of mooring systems the limit tends to be one anchor for every two mooring system. According to the invention a second set of mooring systems B may be added to the first set of mooring systems A. The second set of mooring systems are slightly rotated to the first set but may use already existing anchors. By the use of a first and second set of mooring systems A+B the limit number of anchors tends to one anchor for every three anchoring systems.

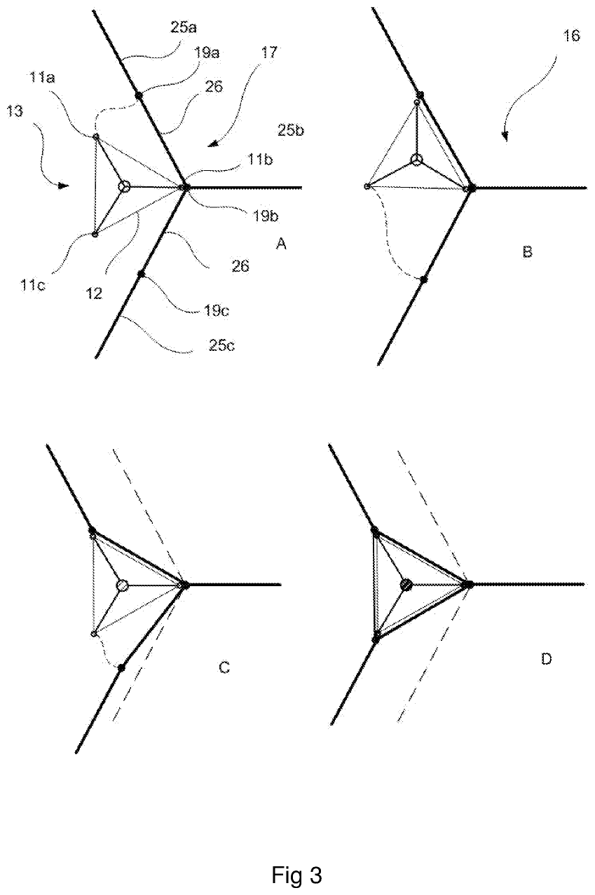

In an embodiment shown in FIG. 3 the mooring unit 18 comprises three mooring elements positioned in a V-shaped pattern. The method of mooring starts with a first float 11a being moored at the first mooring element 19a in position A. The floating platforming is then rotated clockwise to position B whereby the second float 11b may be moored to the second mooring element 19b. While the second float 11b is moored to the second mooring element 19b the floating platform is rotated anticlockwise as shown in position C until the third float 11c reaches the third mooring element 19c in position D where the third float is moored. By this method the floating platform may be moored with one float at the time. The final shape of the mooring system resembles a triangular pattern where all anchor forces are transferred directly to the floating platform in the direction of the arms.

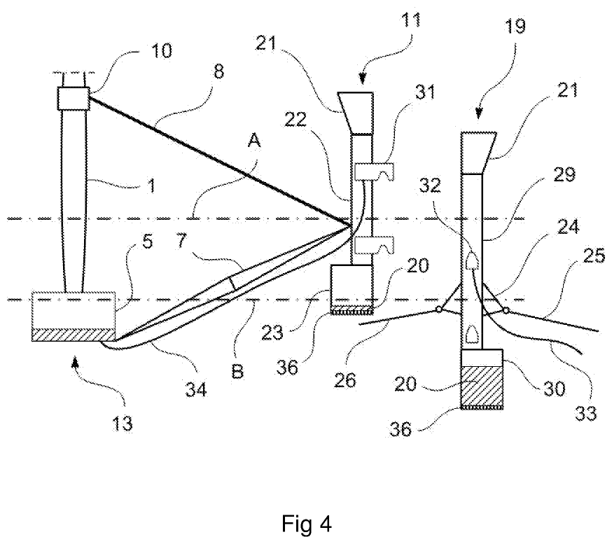

According to the invention the stationary mooring system is equipped with docking means as shown in FIG. 4. The embodiment shown depict part of a floating platform 13 with a float 11 and a mooring element 19 of a mooring system. The floating platform comprises a tower 1 with a main float 5, a first elongated element 8, a second elongated element 7 and a float 11. In the embodiment shown the first elongated element 8 comprises a catenary element and the second elongated element 7 comprises a strut element. The float comprises a funnel shaped body 21, a centre part 22 and a lower body 23 forming together a common cavity. The floating platform is raised to a transport level by emptying water 20 from inner cavity of the float 11 and the main float 5.

In the embodiment shown the float comprises docking means 31 in the form of hooks. The mooring system comprises a plurality of mooring element 19 having a slim cylindric mid section 29 and a bigger cylindric lower body 30. The mooring element is held in position by an anchoring cable 25 and two positioning wires 26. Both the wires and the cables are attached to the mooring element by a span 24. For stabilizing purpose both the float and the mooring element may comprise a ballast weight 36 in the bottom. As shown in FIG. 4 the mooring element may also comprise contact means to connect an external electric cable 33 with an internal electric cable 34.

In the embodiment shown the positioning wire 26 and the anchor cables 25 are cut to indicate that they comprise considerably longer lines at an actual site. The anchor cables may comprise hundreds of meters depending on the sea bed condition and the dept. Preferably suction anchors are used. The positioning wire may be in the range of 100 to 200 meters. Each of the mooring elements comprises three cavities which are structurally connected to form a common compartment. By pumping air or water in or out of the compartment the mooring element the height may be adjusted in the sea to keep a predetermined float position.

By the lightweight construction of the floating wind power platform the construction can be made very big. Accordingly the diameter of the rotor may be 200 m. The total height above the sea level of the tower including the first float may be 130-150 m. The length of the arm may be in the range of 90-120 m. Hence the ratio between the arm and the tower would almost one. The length of the mooring means may be in the range of 25-35 m and the cross section of the mid part 2-5 m. According to the invention the transport position of the platform is about 30 m higher that the submerged position. The draught of the platform under transport may be less than 9 meters.

Although favourable the scope of the invention must not be limited by the embodiments presented but contain also embodiments obvious to a person skilled in the art. The anchor lines may comprise any kind of material with good tensile properties. The mooring element may comprise stationary or temporary means for pre-stressing the anchor lines.

1. Mooring system for mooring a floating platform having a plurality of stabilizing arms with floats, the mooring system comprising an anchoring system containing a plurality of anchors and anchoring cables for anchoring the mooring system in deep sea, wherein the centre part of the mooring system comprises a mooring unit containing a plurality of mooring elements and positioning wires, where each mooring element is connected to an adjacent mooring element with a positioning wire and to an anchor.

2. The mooring system according to claim 1, wherein each mooring element comprises an elongated floating container having a common cavity for air and ballast water.

3. The mooring system according to claim 1, wherein each mooring element comprises a mid part with a cylindrical cross-section.

4. The mooring system according to claim 1, wherein each mooring element comprises a funnel shaped upper part and a cylindric bottom part.

5. The mooring system according to claim 1, wherein the mooring system comprises three mooring elements and the anchor system comprises three anchors.

6. The mooring system according to claim 1, wherein a first mooring element is positioned by three anchors, a second mooring element is positioned by an anchor cable and a positioning wire, and wherein a third mooring element is positioned by an anchoring cable and a positioning wire.

7. The mooring system according to claim 1, wherein three mooring elements form a triangular pattern with a mooring element in each corner, each mooring element being positioned by a positioning wire to the adjacent mooring elements and to an anchor.

8. Mooring facility comprising a vast number of mooring systems according to claim 1, wherein all mooring systems comprising three anchoring cables are anchored adjacently in a hexagonal pattern of anchors, using adjacent anchors in common, whereby the limit of necessary anchors tends to one anchor per two platforms.

9. Method for providing a mooring system for a floating wind power platform comprising a plurality of buoys anchored by anchoring cables in deep sea, the method comprising:
providing a mooring unit containing three mooring elements,
anchoring each mooring unit with an anchor,
positioning the three mooring elements in a triangular pattern by keeping them separated by a positioning wire.

10. Method of docking a floating platform having a plurality of floats with a mooring system according to claim 1, the method comprising:
transporting the platform in a float position to the mooring site,
immersing each of the mooring element of the mooring system to a receiving position by filling ballast water into a buoyancy compartment of the mooring element,
positioning the floats of the floating platform face to face with the mooring elements,
raising the mooring elements and lowering the floats to make the docking means to interlock by regulating the amount of ballast water in the float and in the mooring element respectively.

11. The mooring system according to claim 2, wherein each mooring element comprises a mid part with a cylindrical cross-section.

12. The mooring system according to claim 2, wherein each mooring element comprises a funnel shaped upper part and a cylindric bottom part.

13. The mooring system according to claim 3, wherein each mooring element comprises a funnel shaped upper part and a cylindric bottom part.

14. The mooring system according to claim 2, wherein the mooring system comprises three mooring elements and the anchor system comprises three anchors.

15. The mooring system according to claim 3, wherein the mooring system comprises three mooring elements and the anchor system comprises three anchors.

16. The mooring system according to claim 4, wherein the mooring system comprises three mooring elements and the anchor system comprises three anchors.

17. The mooring system according to claim 5, wherein the mooring system comprises three mooring elements and the anchor system comprises three anchors.

18. The mooring system according to claim 2, wherein a first mooring element is positioned by three anchors, a second mooring element is positioned by an anchor cable and a positioning wire, and wherein a third mooring element is positioned by an anchoring cable and a positioning wire.

19. The mooring system according to claim 3, wherein a first mooring element is positioned by three anchors, a second mooring element is positioned by an anchor cable and a positioning wire, and wherein a third mooring element is positioned by an anchoring cable and a positioning wire.

20. The mooring system according to claim 4, wherein a first mooring element is positioned by three anchors, a second mooring element is positioned by an anchor cable and a positioning wire, and wherein a third mooring element is positioned by an anchoring cable and a positioning wire.
